(19) United States
(12) Patent Application Publication
(10) Pub. No.: US 2003/0222474 A1
(43) Pub. Date: Dec. 4, 2003

(54) In-car drinking device

(76) Inventor: Hsin-Yi Liu, Shincheng Shiang (TW)

Correspondence Address: RABIN & BERDO, P.C., Suite 500, 1101 14th Street, N.W., Washington, DC, 20005, US

(21) Appl. No.: 10/445,055

(22) Filed: May 27, 2003

(30) Foreign Application Priority Data
May 28, 2002 (CN) 02235003.9

(51) Int. Cl. B60N 3/12

(52) U.S. Cl. 296/37.8

(57) ABSTRACT

The present invention provides an in-car drinking device, which is composed of a body and an internal bladder. The power cord is connected to cigar lighter on the control console in the car, and the drinking device is fixed between the two front seats to provide drinking water for the people in the car.

### FIELD OF THE INVENTION

The present invention relates to an in-car drinking device, which is mounted in the internal cabin of a common vehicle, so as to provide hot water for the people in the car to make tea or beverage.

### BACKGROUND OF THE INVENTION

Generally, there is no device providing hot water in a common car, and so if anyone wants a cup of hot tea or beverage during long-distance travel or upon getting off the car, he or she must buy it in the shop, or bring the hot tea or beverage before getting on. Moreover, if there is a baby who needs powdered milk, but there is no hot water in the car, it will be very inconvenient. This occasion occurs from time to time.

### SUMMARY OF THE INVENTION

With consideration of the above situation, the inventor has worked out this prior art based on his enriched experiences in manufacturing and design of related products.

The primary purpose of the present invention is to provide hot water at any time for the people in the car to make tea or hot beverage.

The secondary purpose the present invention is to make common drivers or passengers have a kind of unique enjoyment in the car.

To obtain these, the present invention generally comprises:

A body: this body is the external shell of the drinking device, and is used to protect the interior of the device from being damaged or broken.

An internal bladder: as the main internal element of the drinking device, it is mainly used to contain water, and able to heat the water and maintain the water temperature.

Characteristics:

There is an upper extending part on the upper terminal of the body, and a lower extending part on the lower terminal of the body. But the lower extending part is in an opposite direction with the upper end, so the drinking device is Z-shaped. Moreover, the drinking device can be installed fixedly in the internal cabin of a car.

### BRIEF INTRODUCTION TO THE DRAWINGS

(I) Drawings

FIG. 1: Stereo outside view of the present invention

FIG. 2: Back view of the present invention

FIG. 3: Schematic drawing of the present invention when the upper cover is opened

FIG. 4: Section view of the present invention

FIG. 5: Operational demonstration drawing of the present invention

### (II) CODE NUMBERS

(10) Drinking device

(20) Body

(201) Placement space

(203) Oblique plate

(21) Upper extending part

(212) Discharge button

(22) Upper cover

(222) Sealing cushion

(23) Switching hinge

(25) Lower extending part

(252) Safety switch

(30) Internal bladder

(302) Heating ring

(31) Motor

(33) Power cord

(40) Front seats

(50) Gearshift lever

(202) Storeroom

(204) Extraction opening

(211) Water outlet

(221) Alarm hole

(24) Water volume display

(251) Power switch

(253) Opening

(301) Water inlet

(32) Water pipe

(51) Hand brake lever

### DETAILED DESCRIPTION OF THE INVENTION

In order to make the purpose, characteristics and effect of the present invention understood better by the Examination Committee, detailed description matched with drawings is given hereinafter.

As shown in the drawings, this drinking device (10) consists of a body (20) and an internal bladder (30).

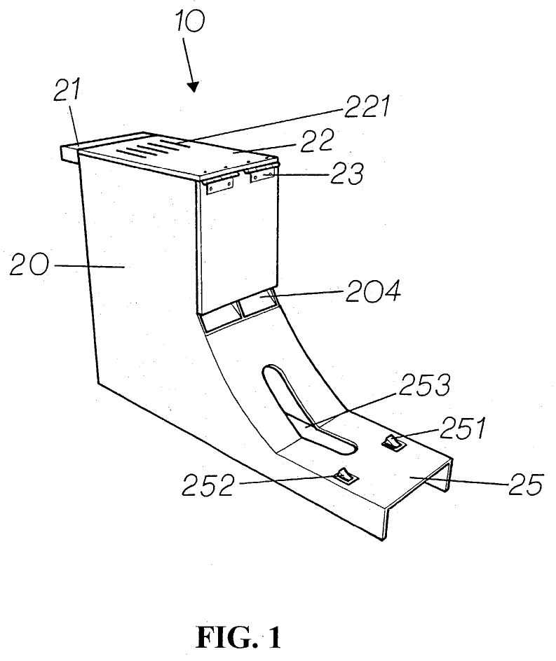

Please refer to FIG. 1. There is a small upper extending part (21) on the upper terminal of the body (20), and a lower extending part (25) on the lower terminal of the body (20). But the lower extending part (25) is in an opposite direction with the upper end, so the drinking device (10) presents a Z shape.

As shown in FIGS. 1˜3, on the top of the body (20) there is an upper cover (22), which is fixed on the body (20) by a switching hinge (23), and is able to make opening and closing motions. On the top surface of the cover (22), there is an alarm hole (221), which is used for making alarms. At the inner side of the upper cover (22) is designed a sealing cushion (222), which is tightly jointed to the edge of the placement space (201), so as to prevent the temperature from dropping down and the water from flowing out.

Inside the body (20), there is a placement space (201) and two storerooms (202), wherein the base plate of the storerooms (202) is an oblique plate (203). The placement space is (201) for placing the internal bladder (30), and the storerooms are for storing tea packets or beverage packets. On the front of the body (20) there is an extraction opening (204), which is connected to the storerooms (202) and used for the people to take out tea packets or beverage packets.

There is a water outlet (211) on the basement of the upper extending part (21), and a plane discharge button (212) nearby. In addition, there is a power switch (251), a safety switch (252) and an opening (253) on the lower extending part (25). Among them, the power switch (251) controls the general power supply of the drinking device (10), and the safety switch (252) controls the action of the discharge button (212). When the safety switch (252) turns on, the discharge button (212) will be activated after being pressed. On the contrary, if the safety switch (252) turns off, the discharge button (212) will not be activated even after being pressed. Moreover, on the back of the body (20) there is a water volume display (24), from which the water volume can be conveniently observed.

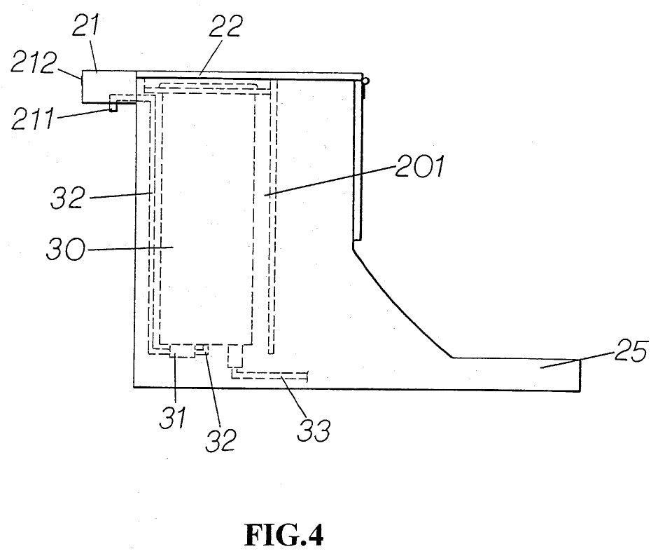

Referring to FIG. 4, place the internal bladder (30) into the placement space (201) of the body (20) and fix it there. A motor (31) is equipped under the internal bladder (30), and water pipes (32) are provided between the internal bladder (30) and the motor (31), and between the motor (31) and the water outlet (211). The motor (31) is used for pumping water, and the water pipes (32) act as the path of the water.

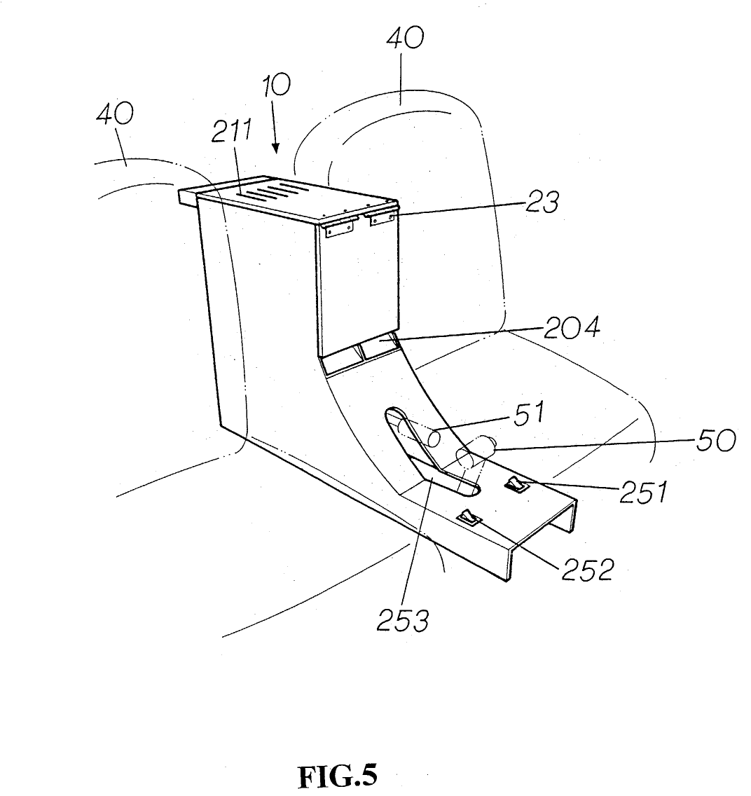

As shown in FIG. 5, the drinking device (10) is located between the two seats (40) in the car. There, a storage box is originally installed, so it must be removed before to install the driving device (10). The opening (253) of the body (20) faces the gearshift lever (50) and the hand brake lever (51), which extends out through the opening (253). Then, connect the power cord (33) of the internal bladder to the cigar lighter in the car, and fix the drinking device (10) between the two front seats (40).

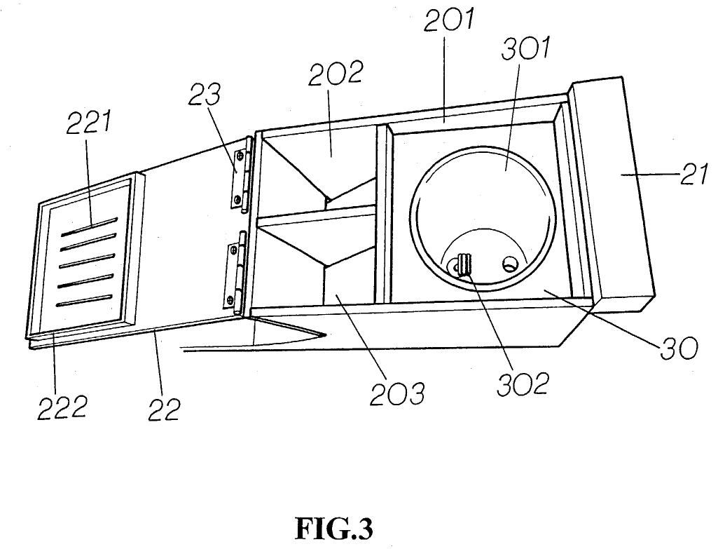

Please refer to FIGS. 3˜5. Open the upper cover (22), and fill in water via the water inlet (301). Close the upper cover (22) and turn on the power switch (251), then the heating ring (302) in the internal bladder (30) will boil the water. When the water inside the internal bladder (30) is boiled, the steam will come out from the alarm hole (221) of the sealing cushion (222), and the alarm hole (221) will give out alarm. So the user can know that the water inside the drinking device (10) is already boiled, and the power switch (251) ought to be turned off.

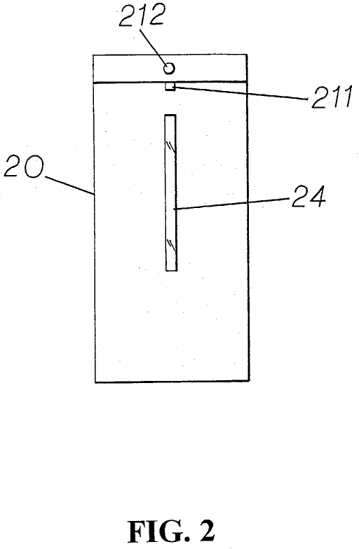

See FIGS. 2, 4 and 5. Turn on the safety switch (252) and press the discharge button (212), and then the motor (31) will pump water from the internal bladder (30) through the water pipe (32) to the water outlet (211). After usage, especially if the device will not be used for a long time, the safety switch (252) ought to be turned off, so as to avoid child passengers from being hurt by the hot water when touching the discharge button (212) by accident during playing the drinking device.

As described above, undoubtedly the present invention is practicable and meets the statutory conditions of the Patent Law. Therefore, hereby the application is formally submitted.

I claim:

1. In-car drinking device, mainly comprising:
A body: this body is the external shell of the drinking device, and is used to protect the interior of the device from being damaged or broken.
An internal bladder: as the main internal element of the drinking device, it is mainly used to contain water, and able to heat the water and maintain the water temperature.
Characteristics:
There is an upper extending part on the upper terminal of the body, and a lower extending part on the lower terminal of the body. But the lower extending part is in an opposite direction with the upper end, so the drinking device is Z-shaped. Moreover, the drinking device can be installed fixedly in the internal cabin of a car.

2. In-car drinking device as claimed in claim 1, wherein there are two storerooms in the body of the device, mainly used to store tea packets or beverage packets.

3. In-car driving device as claimed in claim 1, wherein the discharge button is plane.

4. In-car driving device as claimed in claim 1, wherein there is a safety button on the lower extending part, used for controlling the action of the discharge button. When the safety switch turns on, the discharge button will be activated after being pressed. On the contrary, if the safety switch turns off, the discharge button will not be activated even being pressed.

5. In-car driving device as claimed in claim 1, wherein the device has a fixed shape suitable for various vehicles, and is installed between the two front seats in the car.
